(19) United States
(12) Patent Application Publication
(10) Pub. No.: US 2010/0057618 A1
(43) Pub. Date: Mar. 4, 2010

(54) System, method, and software to manage financial securities via a 3-dimensional landscape

(76) Inventors: Sean Andrew Spicer, Katy, TX (US); James Thomas Albamont, JR., Houston, TX (US)

Correspondence Address: FISH & RICHARDSON P.C., P.O. BOX 1022, MINNEAPOLIS, MN, 55440-1022, US

(21) Appl. No.: 12/378,628

(22) Filed: Feb. 18, 2009

Related U.S. Application Data
(60) Provisional application No. 61/092,275, filed on Aug. 27, 2008.

(51) Int. Cl. G06Q 40/00; G06Q 20/00; G06F 3/048; G06T 17/00

(52) U.S. Cl. 705/64; 705/35; 715/848; 345/420

(57) ABSTRACT

This disclosure involves systems, methods, and software for viewing, managing, or otherwise analyzing financial securities utilizing a three-dimensional display of related data and metrics. This disclosure describes techniques that facilitate the combination of financial data with 3D search technology to provide a user-friendly view and analysis of securities market data. The intuitive visual landscape offers a contextual picture that allows the user to display several layers of information simultaneously. Moreover, the disclosure describes this intuitive mechanism for looking at financial markets and identifying opportunities within a multi-dimensional landscape linked to additional integrated data panes, thus helping enable rapid analysis. The techniques may utilize or facilitate customizable metrics, seamless system compatibility, and integrated portfolio tools. The securities landscape may allow on-the-fly changes to quickly answer user queries. The disclosure further discusses various optimizations that help enable this real-time and intuitive landscape, such as vertex optimizations, color map optimizations, and hypersorting.

### RELATED APPLICATION

This application claims priority under 35 U.S.C. §119 of Provisional Application Ser. No. 61/092,275, filed Aug. 27, 2008.

### TECHNICAL FIELD

The present disclosure relates to visually managing financial data and, more particularly, to efficiently accessing, processing, displaying, or otherwise managing financial securities via a three-dimensional landscape.

### BACKGROUND

Investing in securities and other financial markets generally requires discipline, insight, and data. This data can include incredibly large amounts of information, numbers, and metrics for each market, segment, and individual issue. The financial industry uses several common sources for data both up to the second and historical, including: Bloomberg, Reuters, Morningstar, Standard and Poors, Edgar Online, Dun & Bradstreet, and Hoovers Online. These data sources provide raw data and other information that anyone can use—usually for a significant monthly subscription fee in the thousands of dollars.

This financial data is often hidden in charts, simple graphs, and spreadsheets that present information in a two-dimensional form. But it is believed that over 80% of the human brain is dedicated to visual processing. Lack of motion and geometry (shapes) can cause information to be hidden within static, two-dimensional data. Put differently, staring at numbers in tables or simple graphs is not considered a natural way to analyze a target. Instead, humans better recognize patterns from shapes, particularly shapes in motion with color. For example, converting numbers to shapes reduces cognitive friction and naturally leads the mind to discover patterns.

To date, the financial industry has been served by large investment firms with access to powerful computers to process the copious amounts of data. Even with this access, professionals often miss critical information or other opportunities because enormous amounts of data presented using these charts, graphs, and spreadsheets stretch the limits of human cognitive ability. It becomes difficult to extract meaningful information from large volumes of data. Moreover, this 2D data is often security specific, instead of market wide. As a result, opportunities can be passed by, risk exposure underestimated, and even sophisticated investors can be left relatively helpless—not knowing what they do not know. At the extreme, the individual (or non-professional) investor ends up as a consumer of information of dubious quality—as he or she is typically out of reach from the top tier data providers.

### SUMMARY

At a high level, this disclosure involves systems, methods, and software for viewing, managing, or otherwise analyzing financial securities utilizing a three-dimensional display of related data and metrics. This disclosure describes techniques that facilitate the combination of financial data with 3D search technology to provide a user-friendly view and analysis of securities market data. The intuitive visual landscape offers a contextual picture that allows the user to display several layers of information simultaneously. Moreover, the disclosure describes this intuitive mechanism for looking at financial markets and identifying opportunities within a multi-dimensional landscape linked to additional integrated data panes, thus helping enable rapid analysis. The techniques may utilize or facilitate customizable metrics, seamless system compatibility, and integrated portfolio tools. The securities landscape may allow on-the-fly changes to quickly answer user queries. The disclosure further discusses various optimizations that help enable this real-time and intuitive landscape, such as geometric vertex optimizations, color map optimizations, news tagging, and hypersorting.

For example, one technique may include creating a three-dimensional graphical display space on a client where financial securities information and data is represented by three-dimensional object(s) and attributes. This technique may involve identifying data and information to be represented by three-dimensional object(s). Such identification may occur in response to user input, automatic determination, via loading default values, or combinations thereof. Default values may include i) height of building=market capitalization, ii) equity issue (company name), iii) color represents sector, and so forth. Next, a market set may be identified that specifies the context of securities to be requested, such as geography, exchange, asset class, sector, etc. Example geography may be sub-divided into North America, EMEA (Europe, Middle East, and Africa), and Asia. The market set may be requested from a remote data source. This market set may include data corresponding to metric fields, which can number in the hundreds or more. And the remote source may be server associated with the same entity as the example client, an archive, a data source associated with a third party, or any other appropriate data source. In some instances, the market set may be retrieved from multiple data sources, some of which may be local and other remote. For example, a relatively local source may store a majority of the desired data, while the remote source can provide a delta between that stored locally and the current state of information. The received market-set may be parsed into an internal data model and matched to the requested data and information. This matching could include quality control, double-checking, culling null fields, automatically retrieving missing data, and other data massaging to help ensure a robust data set. A graphical object may be created for each security in the received market-set with attributes that may be mapped to a representational form. Such attributes may include color, shape, shading, height, footprint, location, and so on. The graphical objects may be arranged into a form that is interpretable by an end user as an information landscape, such as building landscape, universe landscape, and so forth.

In another example, a technique may include serving financial securities information to a client three-dimensional graphical display system. This technique may involve receiving a request from a client three-dimensional graphical display system for a set of financial securities information. The location, organization, and integration of data and information necessary to respond to the client request may be determined, and a response to the client request for the set of information requested calculated. In this example, the location may be a physical or logical location, the organization could be a data schema, and the integration could involve aggregation of live and static information or other data sets. The response may be developed according the client request in a format suitable for transmission over the respective network to the client's three-dimensional graphical display system. For example, this development may include compression, encryption, data supplementation, protocol translation, or any other suitable data massaging.

In a further example, a technique can include integrating multiple one, two, and three-dimensional graphical display spaces wherein financial securities information and data is represented by a plurality of three-dimensional objects. This technique may involve selection of a three-dimensional object in one display space. The information represented by the three-dimensional object is used to uniquely identify the underlying security in the system data model, and the system data model is notified of the selection. In other words, the selection of different or changed data in one display can be published to other instantiated display objects. The system data model may publish the selection event to a set of listeners (one, two, or three-dimensional displays). The objects listening to system data model events may respond to the broadcast selection. Example 1D displays can include a head's up display, volume data, price, newswire, and so forth. Example 2D displays can include price charts, volatility charts, earnings charts, and other bars, graphs, and others. In this example technique, the 1D, 2D, and/or 3D displays or windows (or frames) can be linked such that modifying one display effects one or more of the others. For instance, changing the respective data set in the 2D display can change the data displayed in the 1D display. In another example, two 3D displays can be linked such that rotating one display rotates the other at the same speed, viewing angle, and so forth.

In yet another example, one technique can involve combining financial securities information and data to create new information that may then be represented by one or more three-dimensional object attributes. This technique may involve selection of one or more securities information and data points for calculation. A market-set is selected for calculation. The data and information are retrieved from the remote server and used to populate a system data model. The calculated criteria are specified for one or more of the data points. A calculation engine performs the calculations specified on the market set. The results are mapped to attributes of graphical objects representing entries of the market set.

Another example technique may include updating a three-dimensional graphical display space wherein financial securities information and data is represented by a plurality of three-dimensional objects and attributes. This technique may involve requesting the market-set stored in the system data model from a remote data source by, for instance, user-directed refresh or programmed automatic update at a particular time-interval. The market set is received from a remote data source and parsed into an internal data model. The requested data is matched to the data and information stored in the system data model. The arrangement of graphical objects is updated into a form that is interpretable by an end user as an information landscape. Instead of using numbers to create charts and graphs alone, it converts numbers into three-dimensional patterns to create a financial landscape.

The above (or similar) techniques can utilize or benefit a 3D display that can illustrate data and its changes in real-time utilizing different graphical elements, often implementing various graphical optimizations. This data, and its changes, can be all or a subset processed through hundreds of different financial metrics, many of which are unique to the financial space (equities, bonds, derivatives, commodities, currency). Indeed, some of the metrics can be considered dimensionless, such as diversity. To achieve some or all of the example techniques, systems or software can utilize, include, or implement various components such as a 3D client, fast network delivery from a remote source, data integration, (color, shape, and shading), multi-dimensional displays (1D, 2D, and 3D display), and metric calculation engine. Various combinations of these components or modules help provide an information landscape that quickly presents a wealth of financial data that is easily understandable by the user. This interactive, 3D display can create visual patterns from financial data that utilize the natural pattern recognition capability the user's mind so that important information that is hidden from view can be made to stand out. This interactivity can be real-time display of data as it is changing or-being customized. The result can be an improved workflow that can create, evaluate, and modify risk adjusted investment portfolios—in seconds—and at a fraction of the cost. Portfolios that match investors thinking and knowledge can be created for comparison side by side. Performance evaluation (whether historically or in a historical mode going forward) can be done to test ideas (backtesting) without the drudgery of manipulating spreadsheets by hand.

For the professional investor, one or more techniques similar to those above can facilitate rapid analysis and discovery of hidden opportunities when using a three-dimensional landscape approach to finding hidden investment possibilities. For instance, it is believed that there are over 200,000 professionals in the U.S. market who use data and software to manage portfolios on behalf of clients. Many of these professionals use tools such as Yahoo Finance, Google Finance, or other similar tools' to provide data and context for critical investment decisions on behalf of their clients. Partially overlapping with this user-base, approximately 30% use tools such as Factset and Bloomberg (typically at significant cost). The disclosed innovative three-dimensional graphical user-interfaces and the intelligent use of cloud computing helps increase data crunching capacity to the many professionals who can use it, often at a lower cost. Using web-technologies and platform-independent tools, these techniques can deliver a near-complete professional system to the professional investor.

For the individual or “enthusiast” investor, access to the same data and portfolio tools professionals use every day is possible at a fraction of the cost in an intuitive, easy to learn system. It is believed that there are over 5,000,000 non-professional, individual investors in the U.S. These investors are typically enthusiasts who subscribe to one or more financial periodicals such as the Wall Street Journal, Investor's Business Daily, or The Motley Fool. They may watch financial news programs such as CNBC or FBN, and typically own or use software for managing their portfolios (E*Trade, Schwab, etc.). Much of the data come from free sources including Yahoo Finance, Google Finance, chat rooms created for investors or even word of mouth. Using some or all of the present techniques can help such investors test risk balanced portfolios and examine them directly against the universe of investment opportunities visually, all at once through the innovative visualization while (often) taking advantage of the computer graphics processing hardware on generic, standard, consumer, or commonly available desktops and laptops.

Of course, the foregoing example advantages may not be present in every configuration or for every technique or process of the disclosure. While generally described as software, some or all of these aspects may be further included in respective systems or other devices for executing, implementing, presenting, or otherwise analyzing a suitable market, segment, security, or other financial landscape. The details of these and other aspects and embodiments of the present disclosure are set forth in the accompanying drawings and the description below. But other features, objects, and advantages of the preferred or other embodiments will be apparent from the description and drawings.

### DESCRIPTION OF DRAWINGS

FIG. 1 illustrates an example 3-tier system, with data hosted on high-availability web-servers, application servers, and rich clients interfacing over standard HTTP and HTTPs for presenting a real-time financial landscape in accordance with certain embodiments included in the present disclosure;

FIG. 1A illustrates an example deployment using a web-services data delivery architecture, which can allow interaction of clients with remote production data servers from locations with network connections;

FIG. 2 provides one example configuration of modules implementing one or more of the described techniques included in the present disclosure and others similar thereto;

FIG. 3 illustrates an example class diagram of representative data classes utilized by the example system described in FIG. 1;

FIG. 4 illustrates a high level view of a vertex array, color array, and sample entries in that color array according to certain embodiments of the present disclosure;

FIGS. 5A-E depict example Graphical User Interfaces (GUI) involving interactive visual interpretation of complex large financial datasets, including displays presenting the market landscape for securities and a coupling of the visualization system with traditional charts and graphs that can be used side-by-side in accordance with certain embodiments included in the present disclosure;

FIGS. 6A-C illustrates example GUIs that allow the user to further refine or otherwise customize his experience via user-defined metric calculation/computation interfaces and a metric scout interface;

FIGS. 7A-I illustrate example interfaces that present, and controls used for, hypersorting according to one embodiment of the present disclosure;

FIG. 8 illustrates an example flowchart depicting one process for initializing the financial landscape in accordance with default criteria and user selections within a particular implementation of the present disclosure;

FIG. 9 illustrates an example flowchart depicting one process for updating the financial landscape according to user metric selection within a particular implementation of the present disclosure; and

FIG. 10 illustrates an example flowchart depicting one process for processing user customizations of metrics within a particular implementation of the present disclosure.

### DETAILED DESCRIPTION

This disclosure involves systems, methods, and software for viewing, managing, or otherwise analyzing financial securities utilizing a three-dimensional display of related data and metrics. These example systems, methods, and software may include techniques at a remote data source or at the front-end client for facilitating quick financial information delivery or three-dimensional display. Specifically, such techniques may involve creating a three-dimensional graphical display space, interacting with financial securities information and data represented by three-dimensional objects within that space, and identifying, requesting, and populating the graphic display space from a remote location over a network. This helps facilitate interpretation of complex financial data sets in relative context by geographically dispersed end-users. Context may be defined by grouping of industry sector, securities exchange, asset class, or any other appropriate category. The user can select any number of securities metrics that are mapped onto the three-dimensional landscape. Three-dimensional graphical objects may take any form sufficient to convey the information contained in this underlying data, such as semi-rectangular columns (buildings) and spheres. The user may interact with the system by clicking on a three-dimensional object to reveal further information detail in the form of charts, graphs, spreadsheets, textual information, web-links, or secondary three-dimensional landscapes. Upon initialization or user-selection in the graphical space, data sets used to populate the landscape are requested and transmitted to the system via HTTP (or HTTPs) web-services links, SQL database links, or other remote data population methods. One feature may include data elements that are efficiently retrieved for an entire market-set at once in a single request, as opposed to one request per-issue as is typical of other solutions. For example, rather than requesting the Price-to-Earnings (P/E) Ratio for IBM, then for Cisco, then for ExxonMobil and integrating these, the disclosed software can make a request to return the current Price-to-Earnings (P/E) ratio for every company in the US Market, which includes IBM, Cisco, and ExxonMobil, or a select group, perhaps by sector or some other criteria. The client then parses the result into a specialized internal data model from which individual requests can be serviced more quickly. Example data sets may include balance sheets, quantitative metrics, cash flow analyses, earnings updates, news, EOD market data, SEC filings, and so forth for a plurality of securities that can be analyzed in relation to one another via the landscape. In other words, this landscape is a three-dimensional view of the entire market (or selected or filtered subsets, such as by geography, equity type, and so forth) at one time. The user can manipulate this landscape by rotating, zooming, or flying through the landscape of financial data, often without losing the context of the overall landscape or resolution of the particular metrics being displayed.

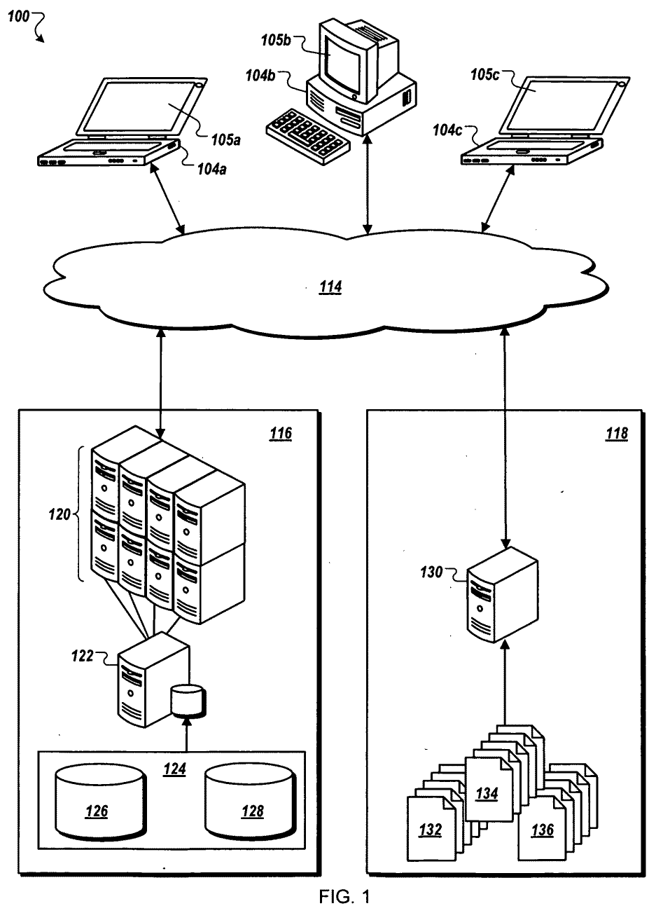

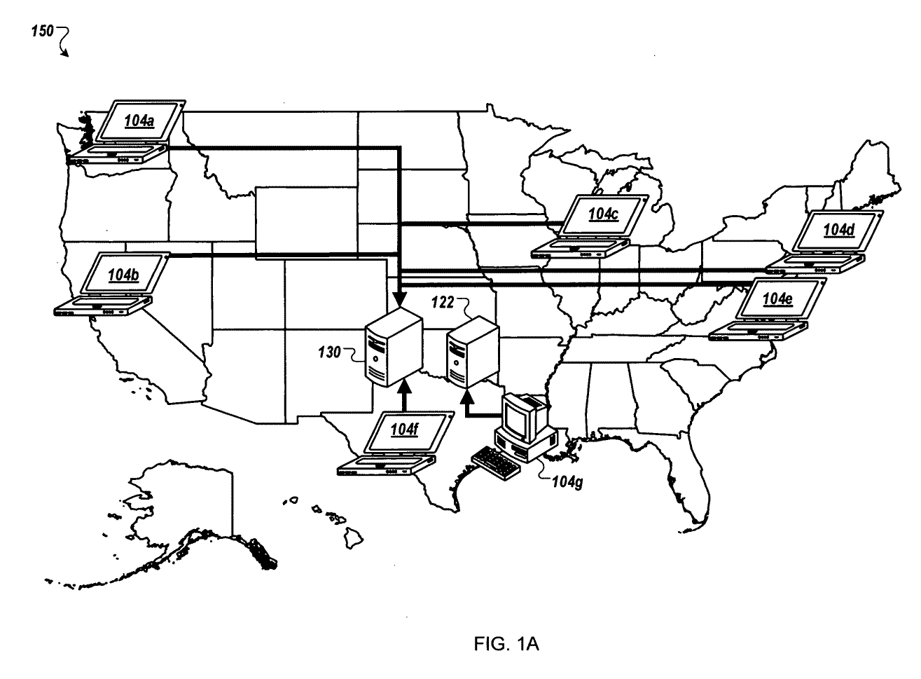

At a high level, an example financial platform implementing some or all of the techniques described herein can include a client and a backend data source, typically resident at a server or server bank as shown by FIG. 1. The 3D client may be a thick or intelligent client that retrieves the information to satisfy a request, but without the overhead of retrieving the entire data set or the need to have a local representation of the data. Moreover, while being implemented in a thick client, the interface may use the more familiar elements of a browser. Additionally, these components allow for standardized or generic data processing and interfaces, as well as easy scalability, as opposed to a customized or in-house solution. The 3D client implements visualization technology that creates visual patterns from data. Accordingly, important information that is hidden from view can be made to stand out when presented using interactive, multi-dimensional methods and procedures.

Very fast, interactive visualization in the example systems may use a software “kernel” that is high performance, optimized, and utilizes the high-quality visualization capability available in hardware today. One of the features of such example software is ease of use and modularity. The software may also allow for custom workflows to be developed that couple traditional tools such as spreadsheets, graphs and charts into a portfolio creation and analysis tool that enables the user to glean relevance and insight from data. It is generally fast, easy to use, and more intuitive than manipulating spreadsheets by hand. The modular nature of the technology will facilitate rapid development of add-on applications that can serve several markets at once with low cost of development. In addition, this architecture may easily serve customers requiring proprietary interconnections with their own software.

To facilitate the low-cost, interactive nature of the display, very large data handling over networks is another design feature of the software system. The technology is limited only by the memory of the host computer running the system, and by the bandwidth of the network connection feeding data to the program. The ability to handle very large datasets interactively helps provide customers with the capability to analyze vast amounts of data—visually—very fast. Data throughput over networks, such as the internet, is enhanced by minimizing the requested data set to reduce bandwidth and increase processing speed. Indeed, the data flow can be optimized be sending compressed text over HTTP (or HTTPs) instead of—or as a supplement to—over complex or congested database connections. These text connections can be much more flexible and quick than static (or hard-coded) connections, ODBC, JDBC, and so forth.

Turning to the illustrated example environment in FIG. 1, the financial platform includes or is communicably coupled with one or more servers 120 or 122, one or more clients 104, and a network 114. The servers may represent one or more logical or physical locations for the financial application provider, such as backend process 116 and a frontend process 118. For example, as illustrated the financial platform may be implemented using application servers 120 and database servers 122; but, for ease of reference, such functionality as appropriate may be embodied within a single server or server bank and will be referred to as server 120. The server 120 includes memory and one or more processors and comprises an electronic computing device operable to receive, transmit, process, store or manage data associated with the system. Generally, this disclosure provides merely one example of computers that may be used with the disclosure. As used in this document, the term “computer” is intended to encompass any suitable processing device. For example, the platform can be implemented using computers other than servers, as well as a server pool or bank. Indeed, the server 120 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. The server may be adapted to execute any operating platform including Linux, UNIX, Windows Server, or any other suitable operating system. According to one embodiment, the server may also include or be communicably coupled with a web server 130 and/or a mail server.

Memory 124 may include any storage or database module and may take the form of volatile or non-volatile tangible memory including, without limitation, magnetic media, optical media, random access memory (RAM), read-only memory (ROM), removable media, or any other suitable local or remote memory component. For example, this memory can include local RAM or any appropriate repository such as, for example, a secure server, a data center or warehouse, a dedicated computer, third party data providers, and others. Regardless of the particular configuration, the memory may typically store some or all of classes, frameworks, applications, backup data, jobs, web services or interfaces, or other information that includes parameters, variables, algorithms, instructions, rules, or references thereto. In the illustrated example, memory 124 stores a financial database 126 and a user (or customer) database 128. The memory may also include any other appropriate data such as VPN applications, firmware logs and policies, firewall policies, a security or access log, print or other reporting files, HTML files or templates, and others. For example, illustrated web server 130 references or stores the website 132, downloads 134, and online help 136.

The server 120 also includes a processor. The processor executes instructions and manipulates data to perform the operations of the server such as, for example, a central processing unit (CPU), a blade, an application specific integrated circuit (ASIC), or a field-programmable gate array (FPGA). Although described as a single processor in the server, multiple processors may be used according to particular needs and reference to processor is meant to include multiple processors where applicable.

The server 120 also includes an interface for communicating with other computer systems, such as the clients, over the network in a client-server or other distributed environment. Generally, the interface comprises logic encoded in software and/or hardware in a suitable combination and operable to communicate with the network. More specifically, the interface may comprise software supporting one or more communications protocols associated with communications such that the network or hardware is operable to communicate physical signals.

The network 114 facilitates wireless or wireline communication between the server and any other local or remote computer, such as the clients. The network 114 may be all or a portion of an enterprise or secured network. In another example, the network 114 may be a virtual private network (VPN) merely between the server and the client across wireline or wireless link. Such an example wireless link may be via 802.11a, 802.11b, 802.11g, 802.11n, 802.20, WiMax, and many others. While described as a single or continuous network, the network 114 may be logically divided into various sub-nets or virtual networks without departing from the scope of this disclosure, so long as at least portion of the network may facilitate communications between the server and at least one client. For example, the server 120 may be located within its own local network 114 (the “provider” network) and the client 104 may be located within its own local network 114 (the “customer” or “analyst” network), with them being connected across a third network 114. In other words, the network 114 encompasses any internal or external network, networks, sub-network, or combination thereof operable to facilitate communications between various computing components in the system. The network may communicate, for example, Internet Protocol (IP) packets, Frame Relay frames, Asynchronous Transfer Mode (ATM) cells, voice, video, data, and other suitable information between network addresses. The network 114 may include one or more local area networks (LANs), radio access networks (RANs), metropolitan area networks (MANs), wide area networks (WANs), all or a portion of the global computer network known as the Internet, and/or any other communication platform or systems at one or more locations such as the example in FIGURE IA. In certain embodiments the network 114 may be a secure network associated with the enterprise and certain local or remote clients 104.

The client 104 is any computing device operable to present the user with the three-dimensional landscape in an appropriate form. To do so, the client 104 may connect or communicate with the server 120 or other components on the network 114 to collect financial data, metrics, updates, news, or other information that can enhance the user's experience or analysis. At a high level, each client 104 includes at least the GUI 105 and, in some cases, an agent and comprises an electronic computing device operable to receive, transmit, process and store any appropriate data associated with the backup system. It will be understood that there may be any number of clients 104 communicably coupled to the server 120 (or 122 and 130). For example, the clients 104 can include one local client and three external clients to the illustrated portion of the network. Further, “the client,” “customer,” “analyst,” “trader,” “investor,” and “user” may be used interchangeably as appropriate without departing from the scope of this disclosure. For example, the investor may also be a user of the client. Moreover, for ease of illustration, each client 104 is described in terms of being used by one user. But this disclosure contemplates that many users may use one computer or that one user may use multiple computers. As used in this disclosure, the client 104 is intended to encompass a personal computer, touch screen terminal, workstation, network computer, kiosk, wireless data port, smart phone, personal data assistant (PDA), one or more processors within these or other devices, or any other suitable processing device. For example, the client 104 may be a laptop that includes an input device, such as a keypad, touch screen, mouse, or other device that can accept information, and an output device that conveys information associated with the operation of the server or the clients, including digital data, visual information, or the GUI 105. Both the input device and output device may include fixed or removable storage media such as a magnetic computer disk, CD-ROM, or other suitable media to both receive input from and provide output to users of the clients through the display, namely the GUI 105.

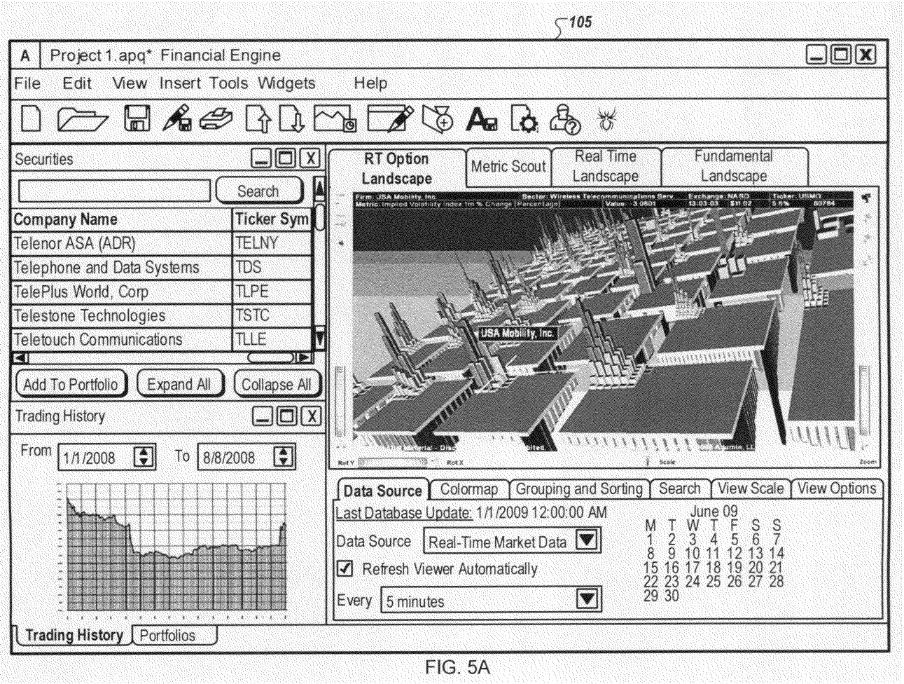

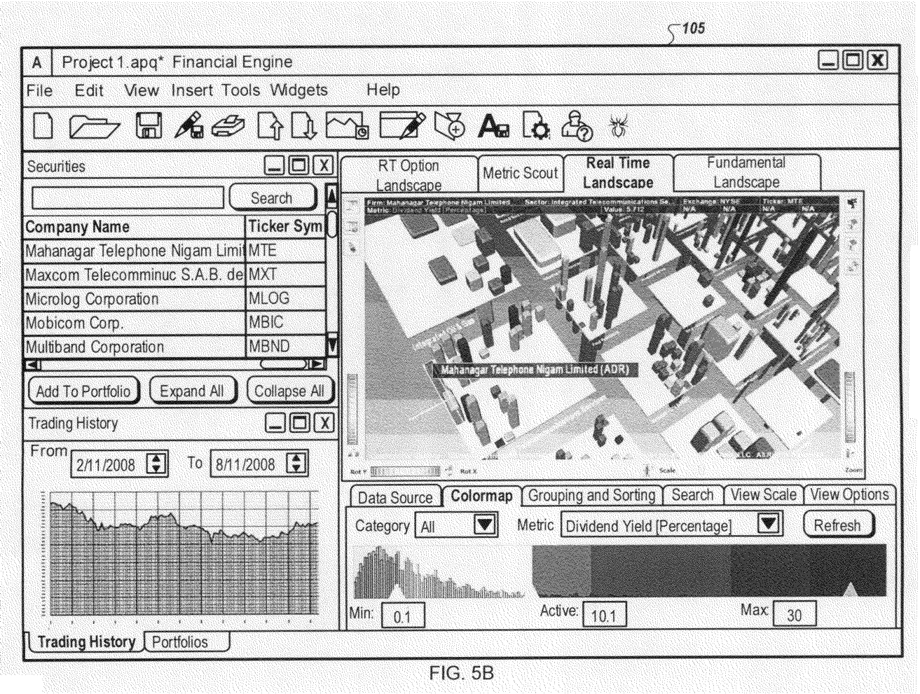

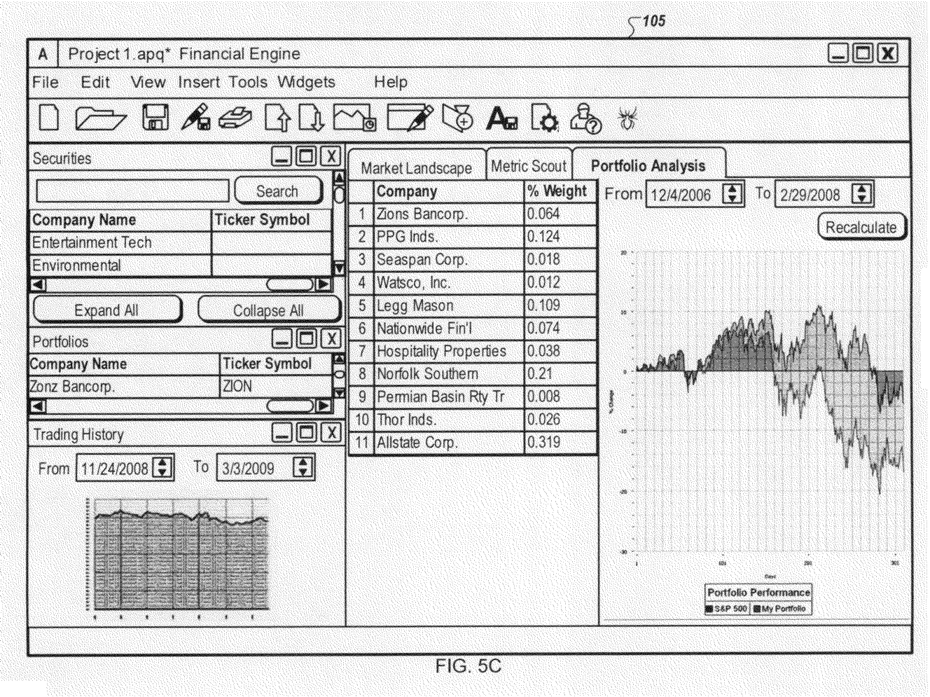

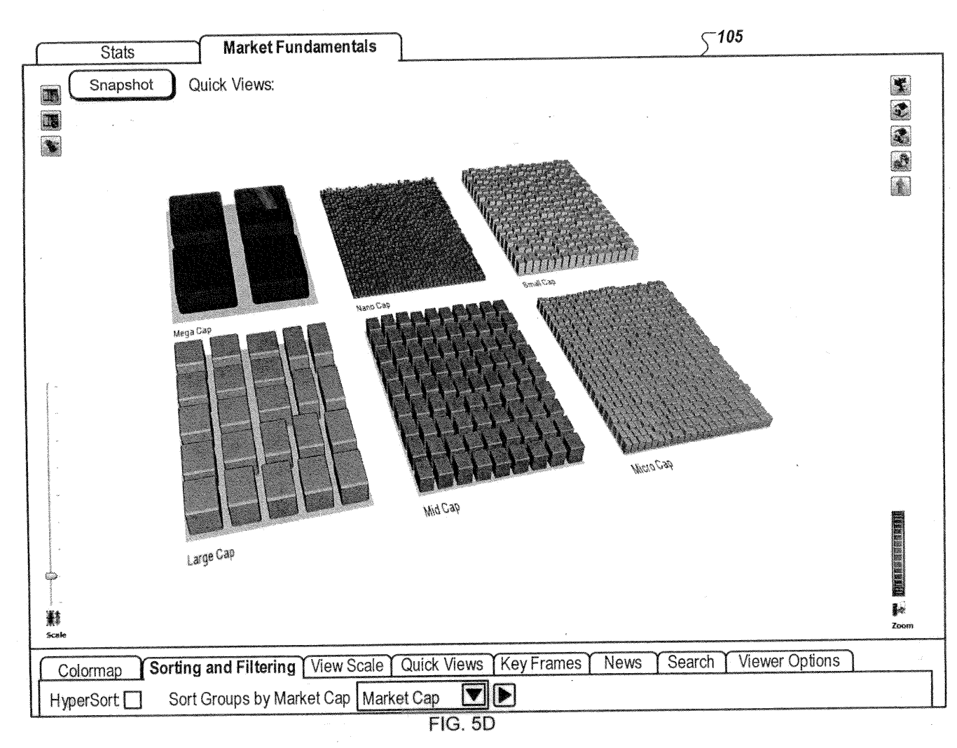

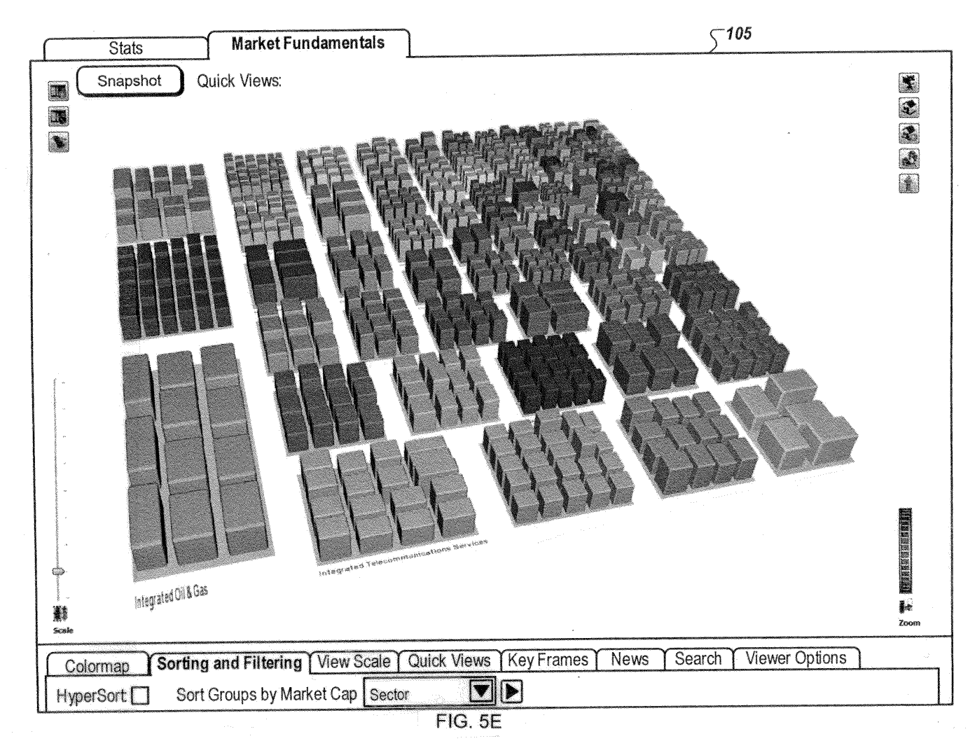

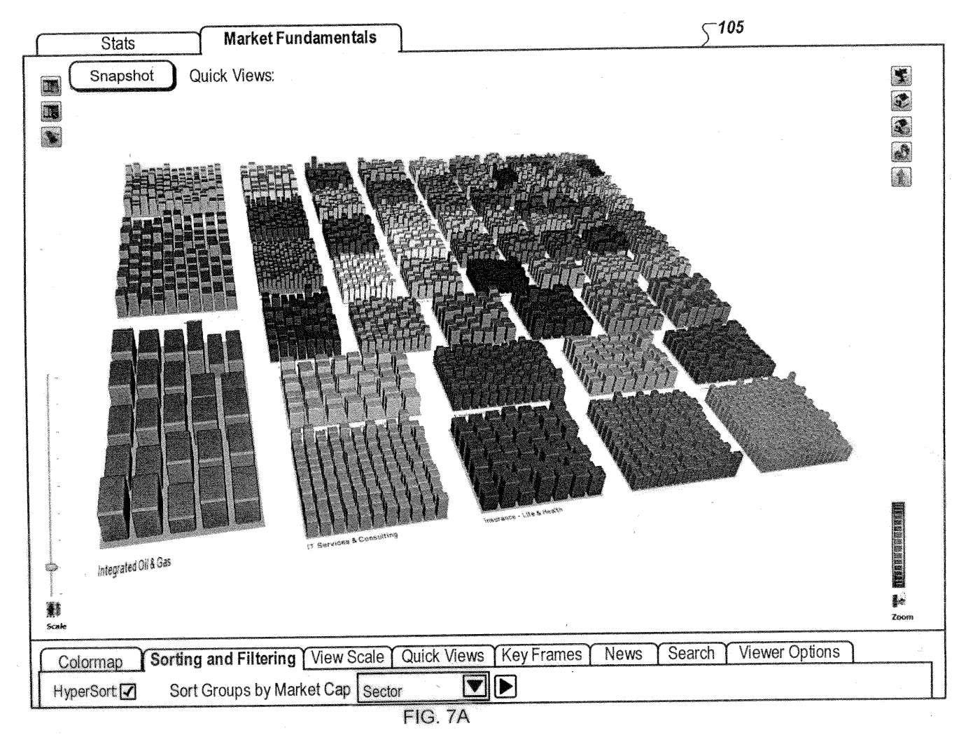

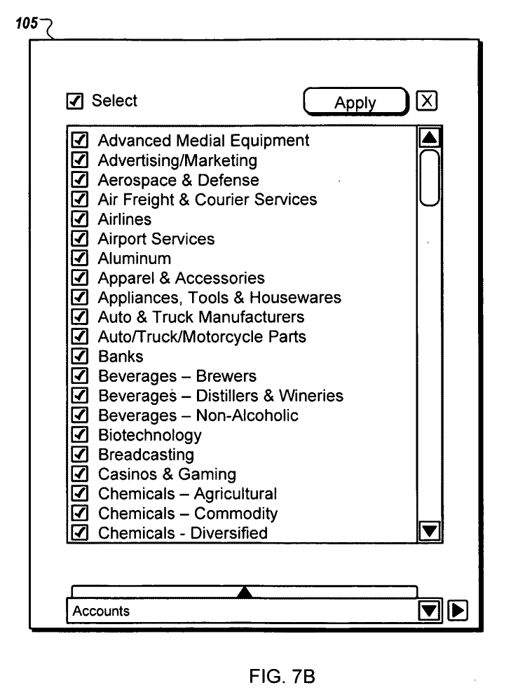

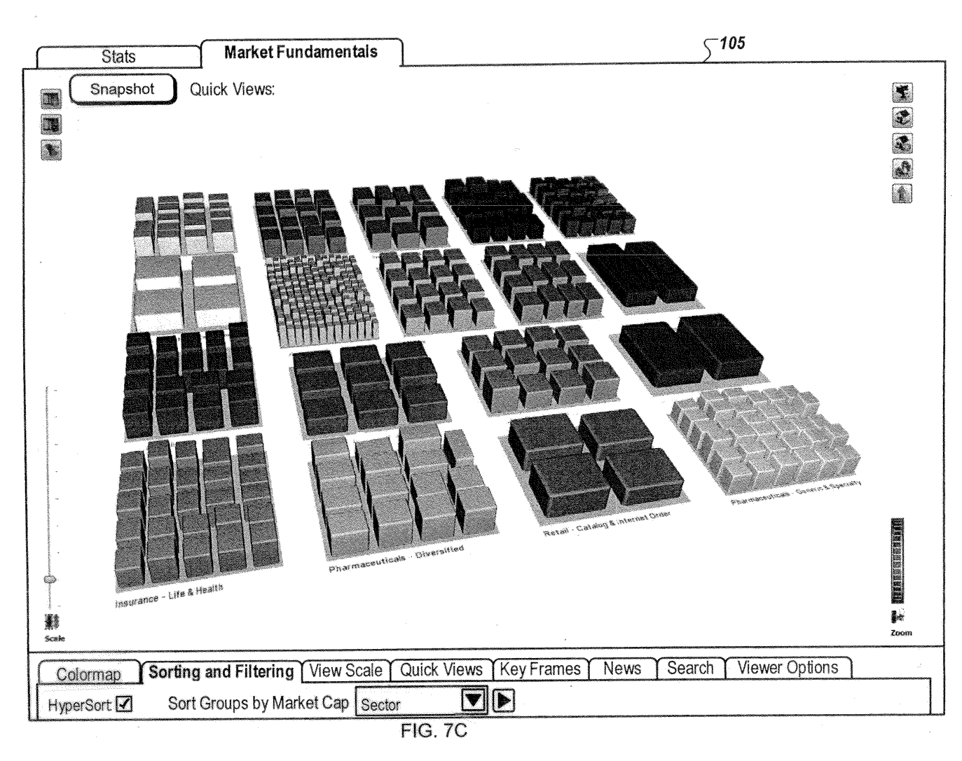

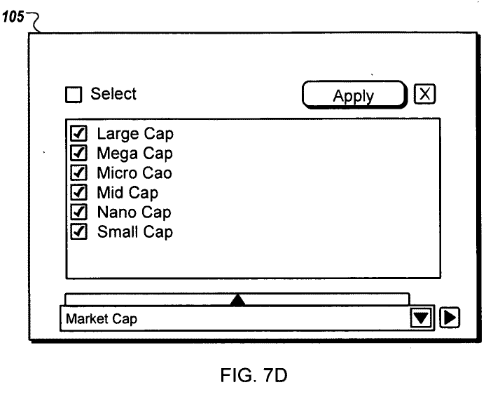

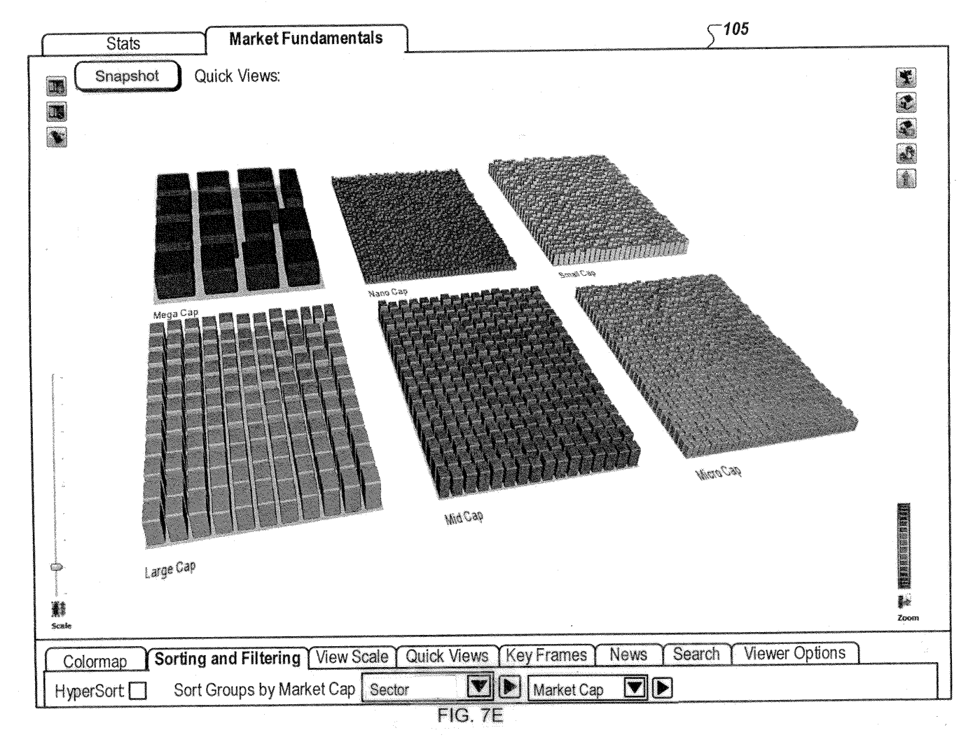

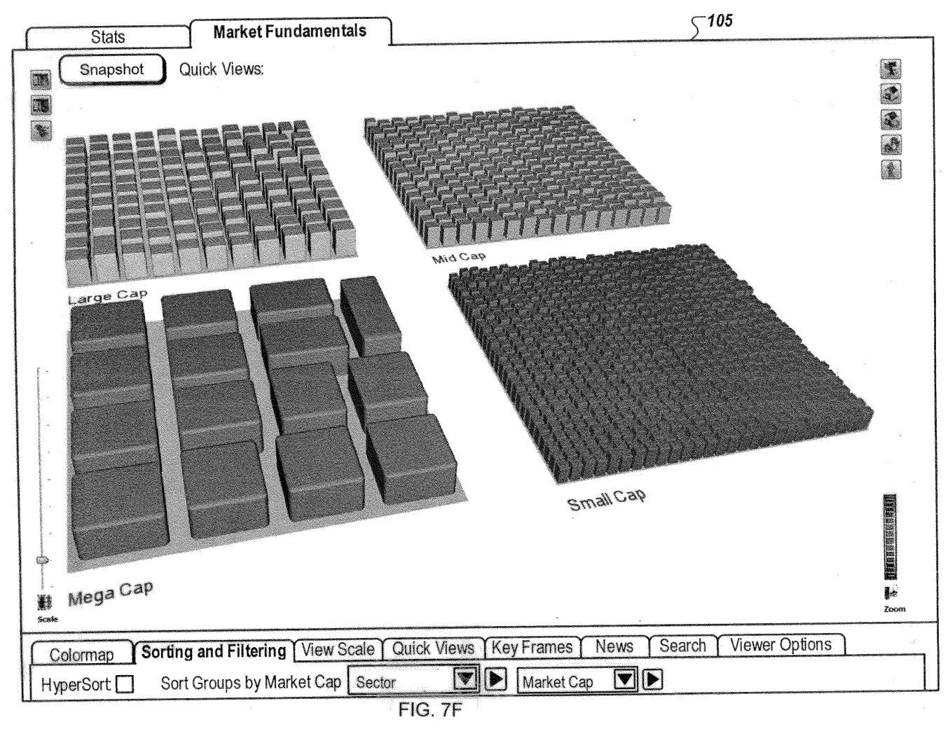

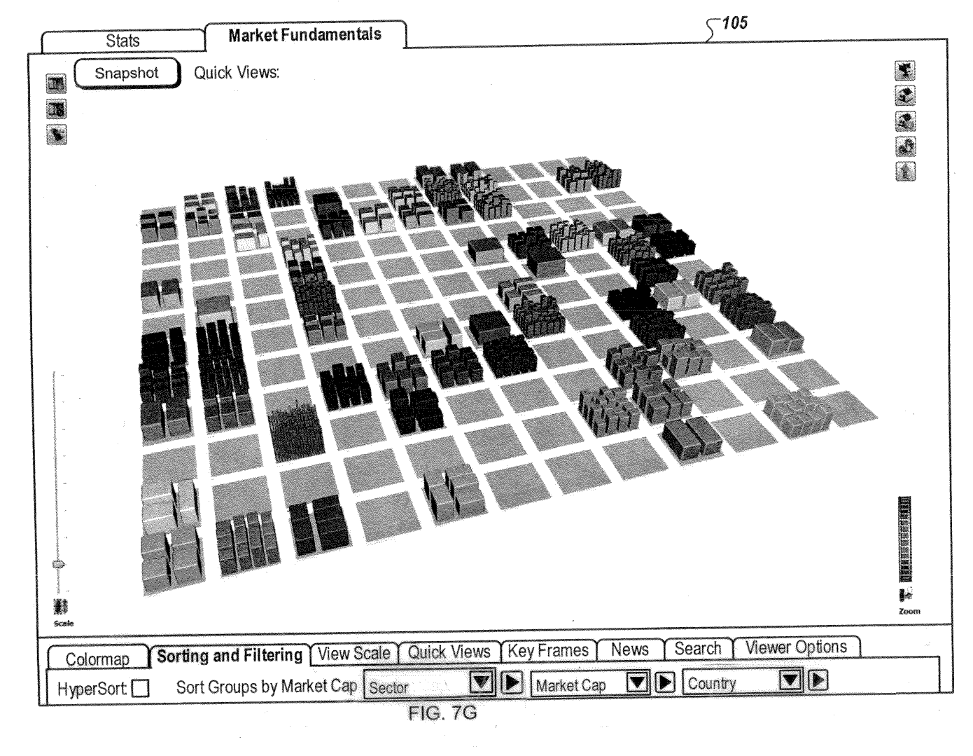

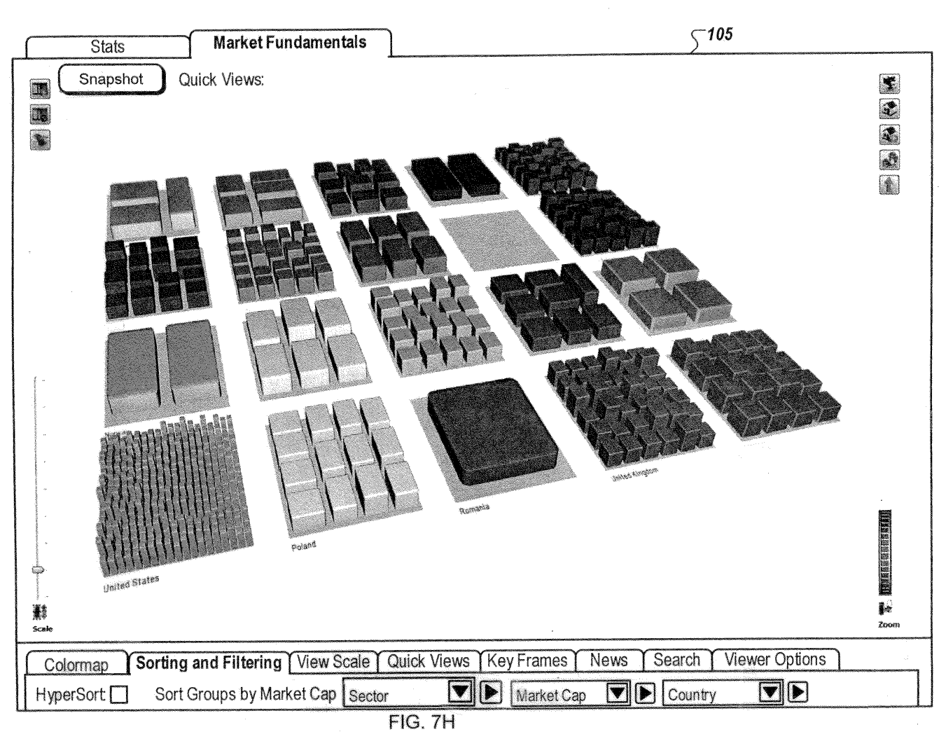

The GUI 105 comprises a graphical user interface operable to, for example, allow the user of the client to interface with at least a portion of the platform for any suitable purpose, such as viewing large financial data sets in a three-dimensional landscape. Generally, the GUI 105 provides the particular user with an efficient and user-friendly presentation of financial data provided by or communicated within the system. Example data displays are shown in FIGS. 5, 6, and 7. The GUI 105 may comprise a plurality of customizable frames or views having interactive fields, pull-down lists, and buttons operated by the user. For example, the GUI 105 may include sliders or other controls that allow user adjustment of the graphical representation of the financial data (such as building height, object density, rotation and other animation, zooming and fly through and so on). The GUI 105 is often configurable, supports a combination of tables and graphs (bar, line, pie, status dials, etc.), and is able to build real-time portals, where tabs are delineated by key characteristics (e.g. site or micro-site). The GUI 105 is further operable to generate or request historical or other transactional reports. Generally, historical reports provide critical information on what has happened including static or canned reports that require no input from the user and dynamic reports that quickly gather run-time information to generate the report. Therefore, the GUI contemplates any suitable graphical user interface, whether thick or thin, such as a combination of a generic web browser, intelligent engine, and command line interface (CLI) that processes information in the platform and efficiently presents the results to the user visually. The server can accept data from the client via the web browser (e.g., Microsoft Internet Explorer or Mozilla Firefox) and return the appropriate HTML, PHP, or XML responses to the underlying engine using the network.

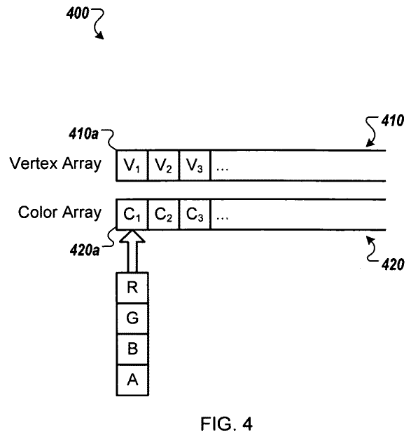

This GUI 105 is generally considered a three-dimensional graphical display space where financial securities and other issues information and data is represented by a plurality of three-dimensional objects and attributes. This display space can illustrate data and its changes in real-time utilizing different graphical elements. For example, the display may present various U.S. equities by sector and price using a building-type landscape. In this case, each building would represent a particular equity with its footprint representing the number of shares and the height representing the price, and the neighborhood representing the sector (such as energy, software, financial or banks, etc.). In certain configurations, each building may comprise 96 vertices (perhaps stored in a vertex array 410) and 188 triangles, which may include 182 tristrips and 6 triangles. As shown the example diagram 400 in FIG. 4, stored with each vertex 410a can be a color 420a structured in color array 420. Each entry in the color array can represent the RGBA (Red Green Blue Alpha) color space using float values, where alpha commonly represents opacity or transparency. To help optimize or enhance data flow and graphical processing, the particular metric may be stored in the alpha channel, which could greatly reduce the amount of data being processed perhaps using post interpolation lookup. For example, the alpha variable could be populated using the ENT/EBITDA. Moreover, the presentation of this financial data may optimize the use of the graphics card's vertex cache. For example, the matrix composites may be flattened into the nodes. In another example, a lookup table can be populated (perhaps keyed on OpenGLRenderString) with optimization settings for particular graphics card. As such, the flow of the information presentation can be three-dimensional, as well as highly interactive at HDTV rates, while displaying large amounts of information and metrics in a more readable, intuitive form.

As illustrated in representative FIGS. 5A-E, the GUI 105 can present information in various forms. For example, throughout a trading session, the user can watch as the sizes of the buildings dynamically change to match activity across the particular market. In this way, the user can identify the more active or volatile sectors and then perhaps watch a linked newswire to determine the cause. Specifically, FIG. 5A illustrates one example interface that presents an RT option landscape, FIG. 5B illustrates one example interface that presents a real time landscape organized by sector, FIG. 5C illustrates one example portfolio analysis interface, FIG. 5D illustrates one example interface that presents a market fundamentals organized into market cap neighborhoods, and FIG. 5E illustrates one example interface that presents a market fundamentals organized into sector neighborhoods. Among many other things, this could help the investor identify sector that are ripe for investment or should be left alone. Further, using these techniques, it is possible for the investor to test risk-balanced portfolios and examine them directly against the universe of investment opportunities visually and at once. For example, in one configuration, the GUI 105 includes a full three-dimensional landscape without substantive or noticeable loss of detail, as well as one or more other (1D, 2D, or 3D) display spaces that can be linked via listeners to be automatically updated according to various events, such as user selection. In another example, the user may be able to select a “goodness” metric that defines the importance, value, growth or other interesting metric, where often a lower value is desired. In this example, the user may define the “importance” of individual metrics on a scale between 0 and 1. For instance, the user may establish the importance of P/E at 0.5, dividend yield at 0.75, and EBITDA margin at 0.25. Here, if a first issue has a P/E of 25, a dividend yield of 0, and an EBITDA margin of 12%, then the goodness value could be 0.8222. To calculate this number, software may first have determined the individual metric's contribution to the goodness metric (total scale values=1.5 (0.5+0.75+0.25) and, for example, P/E contribution is 0.33 (0.5/1.5) and dividend yield is 0.5 (0.75/1.5). Next, the software can calculate the ranking of that issuers metric compared with some target value (say 25 of 15, 0 of 5, and 12 of 30), resulting 0.66, 1, and 0.6. The metric's contribution is then multiplied against the ranked value to determine the “goodness” value ( (0.66*0.33)+(1*0.5)+(0.6*0.17) ). In another case, the “goodness” metric may implement a Gaussian function of importance [0, 1] times the exp ( ((x−target value) squared)/2 times standard deviation squared).

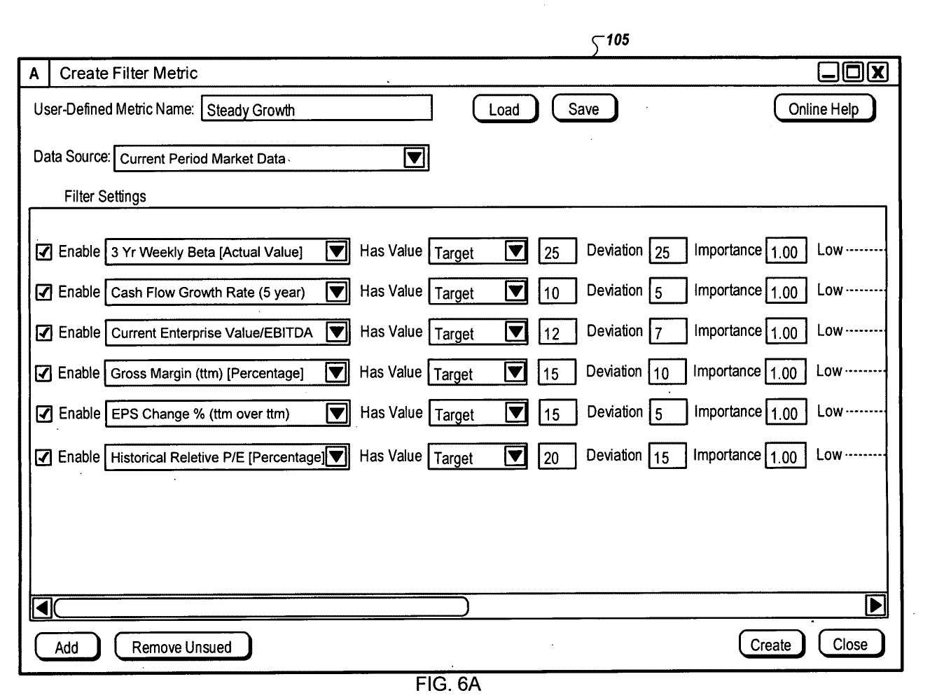

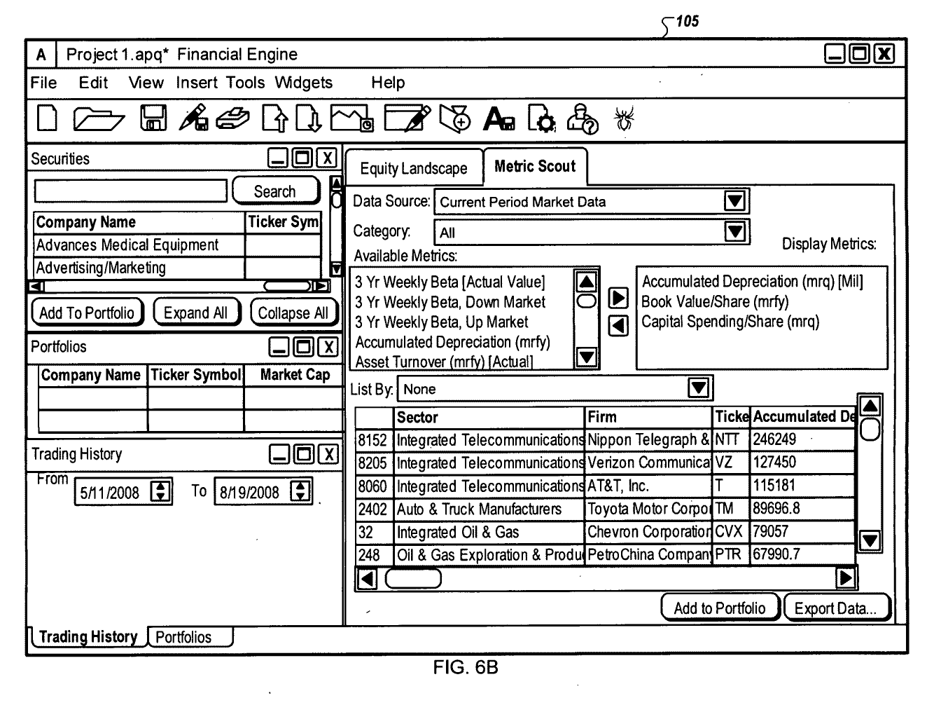

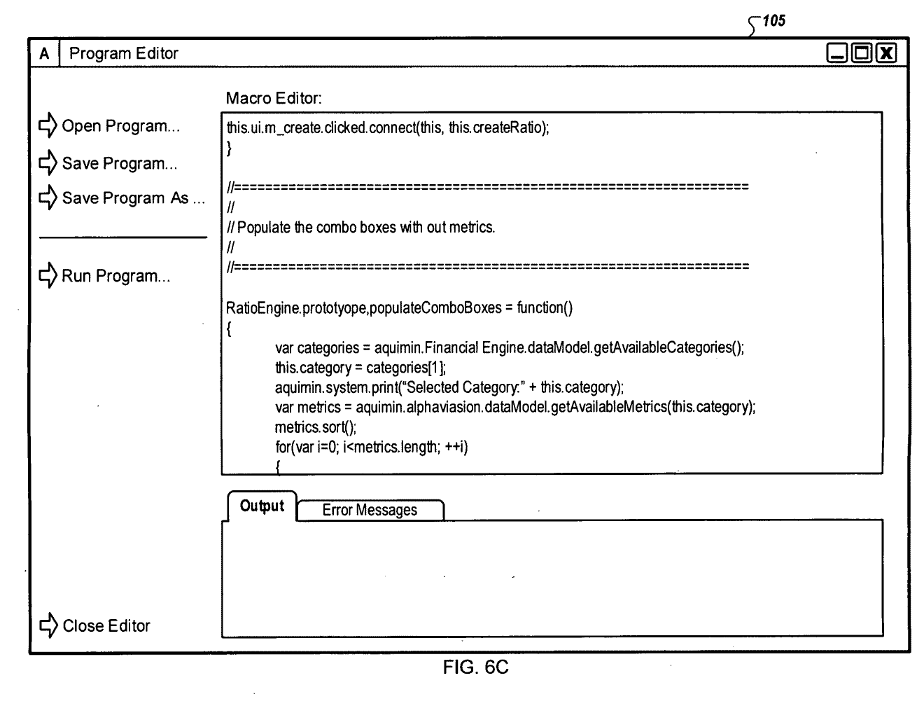

In certain embodiments, the client 104 executes this software through a financial analysis engine 200, which is any software operable to invoke or execute certain described processes and that presents the financial information in a 3D-capable interface, such as the GUI. For example, the financial engine 200 may represent a thick client that, for instance, can be downloaded for free or for a fee; this thick client would often include a number of connections to the backend server and other data repositories. In another example, the financial engine 200 may represent an applet or other client-side intelligence embodied within a web page or other similar thin client. Regardless of the particular implementation, “software” or “computer readable instructions” may include any software, firmware, wired or programmed hardware, or any combination thereof (embodied on or in tangible computer readable media) as appropriate to instruct the respective one or more processors. Indeed, the financial analysis engine 200 may be written or described in any appropriate computer language including C, C++, Java, Visual Basic, assembler, Perl, any suitable version of graphics software or APIs, as well as others. It will be understood that the engine 200 may include any number of sub-modules, such as a business application and third party modules or libraries, or it may instead be a single multi-tasked module that implements the various features and functionality through various objects, methods, or other processes. For example, the engine 200 may include or invoke a metric computer or calculator module. This metric calculator module, perhaps presenting an interface similar to FIG. 6A, allows the user to manipulate the data received from the remote source within his local programming environment. More specifically, it can provide the ability to create customized, or user-defined, metrics, which provides substantially more than mere filters or spreadsheets. This ability utilizes remote data that is automatically displayed in a visually intuitive fashion. In certain configurations, the engine may implement functions or web services including i) GetFirms( ) that returns values such as firm name, ticker symbol, industry group code (sector) (the return values may also include additional (not required) fields such as actual hexadecimal identifier (Representation Number) TaxID (SIP), and exchange code); ii) GetAllItems( ) that returns item name and item code (perhaps all fields); and iii) GetMetric( ) that gets value from database according to field name (also returns hex value to-tie to company). Indeed, FIG. 6B illustrates an example Metric Scout interface that allows users to rapidly extract, compare, sort, and group metrics in tabular (spreadsheet) format. Once organized, groups of firms identified within the metrics scout can be used to form a “Watch List” or group of portfolio positions. These positions can be analyzed and back tested using historical information from other portions of the program. The financial engine 200 may also provide, as shown in example FIG. 6C, a program or macro editor that offers the user the ability to further customize his experience.

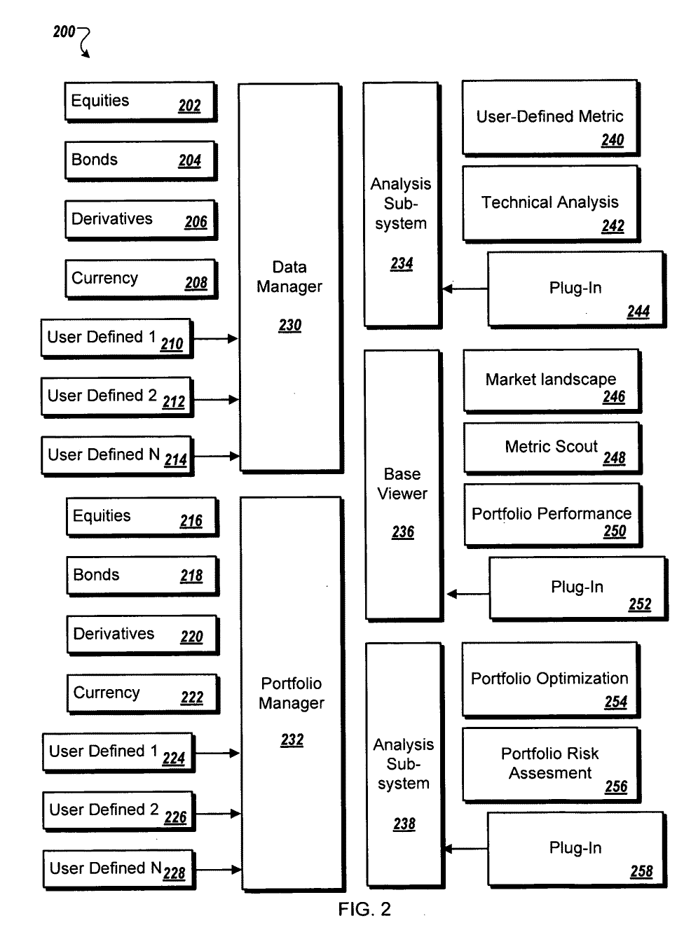

In some situations, the financial engine 200 may be configured to automatically limit the breadth of available information or program functionality according to user, user roles, license or account type, user selection, network bandwidth, defaults, time of day, market availability, and so forth. Further, while described as internal to the client or the server, respectively, one or more processes associated with the financial analysis engine may be stored, referenced, or executed remotely from that device. For example, a portion of the financial analysis engine may be a local library or process, while another portion of the financial analysis engine may be an object bundled for processing at a remote client. Thus the client may also include, reference, or execute an agent to assist in data collection and presentation. The agent may be any script, library, object, executable, service, daemon, or other process. In another example, the majority of processes or modules may reside—or processing takes place—on the client. Moreover, the engine 200 may be a child or sub-module of another relatively local software module or enterprise application (not illustrated) without departing from the scope of this disclosure. Such configurations may use modules such as those illustrated in FIG. 2 or other modules with similar functionality as appropriate.

Specifically, FIG. 2 illustrates an example configuration or schematic of the financial engine 200. As noted above, such a configuration is an example for illustrative purposes. The illustrated financial engine 200 includes a number of modules such as a data manager 230, a portfolio manager 232, an analysis subsystem 234, a base viewer 236, and an analysis subsystem 238. The data manager 230 interfaces with an equities module 202, a bonds module 204, a derivatives module 206, and a currency module 208. The data manager 230 can also interface with a number of user defined modules such as a user-defined module 1 210, a user-defined module 2 212, and/or a user defined module N 214. Likewise, the portfolio manager 232 interfaces with a number of component modules. These component modules can include an equities module 216, a bonds module 218, a derivatives module 220, and a currency module 222. The portfolio manager 232 can also interface with a number of user defined modules 224, 226, and 228. The illustrated analysis subsystem 234 interfaces with a user-defined metric module 240, a technical analysis module 242, and a plug-in module 244. The example base viewer 236 interfaces with a market landscape module 246, a metric scout module 248, and a portfolio performance module 250. The base viewer 236 can interface with a plug-in module 252. The representative analysis subsystem 238 interfaces with a portfolio optimization module 254, a portfolio risk assessment module 256, and a plug-in module 258.

Using some or all of the foregoing example components and configurations, the server 120 (or server bank) can retrieve data from multiple data sources based on a (software or user-directed) request from a client 104. In this instance, each of the one or more data sources may be stored in an enterprise-wide repository as one or more tables in a—relational database described in terms of SQL statements or scripts. In another embodiment, the stored data—whether financial, user, parameters, and so on—may be formatted, stored, or defined as various data structures in text files, eXtensible Markup Language (XML) documents, Virtual Storage Access Method (VSAM) files, flat files, BTree files, comma-separated-value (CSV) files, internal variables, or one or more libraries. In short, this financial data may comprise one table or file or a plurality of tables or files stored on one computer or across a plurality of computers in any appropriate format. Often, the data can be fetched and cached in real time (historical fundamental data: company history, annuals, dollar value of annual loans, and so forth) and then stored in the respective database. For example, the server-oriented database may be refreshed or otherwise intelligently updated from other remote data sources, such as six times a day via XML over File Transfer Protocol (FTP). These other remote data sources may comprise third parties that expose API sets or web services, perhaps via subscription, that provide the data to the server. This data can be fundamental information that doesn't change over the course of one day. For changing data (such as earnings release), it may be imported directly into the server's memory or (at least a subset) communicated directly to the client 104. In certain situations, the server 120 may fold data streams into memory and key to towards an ISIN field. In this way, each client 104 is able to easily access the data. Such access can be further enhanced through use of (encrypted) GZIP textual or octet-stream data communications through GZIP plug-ins, which are often already present at clients 104 and also allow clients 104 to add their own data streams. Once sent to the client, it is expected that certain clients 104 will cache the information (via HTTP or offline repository) such that request information may be locally obtained, perhaps using a hashed table, thereby reducing process time. In this example, each data item communicated from the server 104 may include a cache header with a timestamp and cache validity flag or length. When warranted, server 102 may force a cache deletion or purge from the client 105.

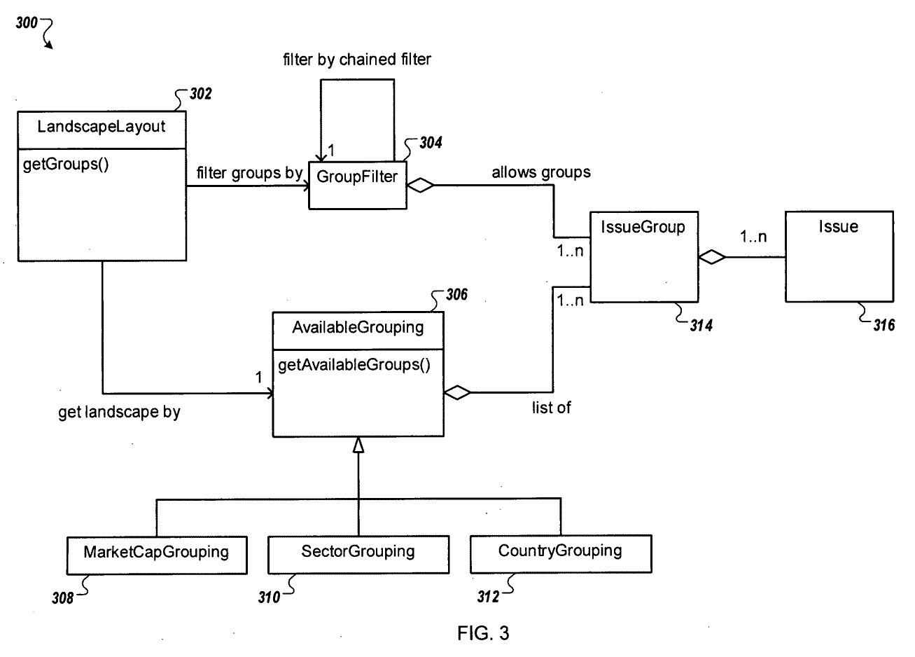

For example, some of the financial data may be organized similar to that illustrated in example FIG. 3. Specifically, FIG. 3 illustrates an example class or entity-relationship (ER) diagram 300 in one data configuration. This example includes the following data objects or items: Issue 316, IssueGroup 314, AvailableGrouping 306, GroupFilter 304, and LandscapeLayout 302, as well as GroupNode, IssueNode, and TreeMap. The Issue class represents a financial asset, such as a stock or bond. IssueGroup can be considered a collection of issues that share a common attribute, such as, for example, mid-cap stocks, or banking stocks.

The AvailableGrouping is a collection of related IssueGroups used to define the arrangement and content of the landscape. They can be used to filter; filtering an IssueGroup removes those issues from the landscape. AvailableGroupings are also used to specify the overall layout: each issue group becomes a “plate” or “neighborhood” on the landscape, and the issue contained in that group become the “buildings.” Some example AvailableGroupings 306 are groupings by Market Cap 308, Sector 310, Country 312, or Index. For example, the “Sector” AvailableGrouping could contain Banks, Airlines, and Precious Metals as IssueGroups.

A GroupFilter class can allow filtering of individual IssueGroups using an AvailableGrouping. GroupFilters can be chained to other GroupFilters such that the final displayed issues are the subset of issues not filtered out by any GroupFilter in the chain. A LandscapeLayout class can represent a particular layout of issues on a landscape. Specifically, it represents the layout using a collection of one or more chained GroupFilters to select the visible issues and an AvailableGrouping to describe how the final issues are arranged.

IssueNode is generally a node in the scene graph displaying an issue. Typically displayed as a building with color. A GroupNode can be a node in the scene graph displaying a group of issues. Typically displayed as a gray plate with the group name in front, and a collection of individual IssueNodes. A TreeMap class can implement a Tree Map algorithm. It is typically used to lay out the IssueNodes contained within a GroupNode. It is also used to layout out the GroupNodes on the overall landscape. It will be understood that this data organization or class relationship illustration is merely an example of how data (and classes and their methods) may be implemented.

Regardless of the particular organization, the financial data can then be presented to the user via a real-time interface that allows the user to zoom, spin, and perform other intuitive graphical processes that help enhance the experience, processing, and analysis. For example, the financial engine may implement a Scene Graph Object Layout Algorithm that describes how a LandscapeViewer class takes a layout from the example LandscapeLayout class and arranges the scene graph objects to match. This example algorithm may use any suitable variables, including groupTreeMap (a TreeMap that lays out a collection of GroupNodes) and groupNodeList (a list containing the GroupNodes in the scene graph). This example algorithm can be implemented according to the following psuedocode:

```
CLEAR groupTreeMap
FOR each groupNode in groupNodeList
    REMOVE all IssueNodes from groupNode
END LOOP
SET displayedGroupList to list of groups returned by
LandscapeLayout
WHILE (# of GroupNodes in groupNodeList < # of IssueGroups
in displayedGroupList)
    CREATE new GroupNode;
    ADD groupNode to groupNodeList
END WHILE
FOR int i = 0 to number of groups in displayedGroupList
{
    SET currentGroupNode to groupNodeList[i]
    SET currentGroup to displayedGroupList[i]
    SET currentGroupNode’s name to currentGroup’s name
    ADD currentGroupNode to groupTreeMap
    CREATE issueTreeMap
    FOR each Issue in IssueGroup
    {
        LOOKUP issueNode for Issue in issueNodeList
(created at startup)
        ADD issueNode to currentGroupNode
        ADD issueNode to issueTreeMap
    }
    CALL issueTreeMap.layout( ) to arrange IssueNodes
within currentGroup
}
CALL groupTreeMap.layout( ) to arrange groups on landscape)
REDRAW SCREEN
```

In another example, the financial engine may implement a Landscape Layout algorithm that describes how the LandscapeLayout class generates the list of IssueGroups representing the current layout. The list of IssueGroups and Issues can be filtered by the presence of chained GroupFilters in the LandscapeLayout. This example algorithm may use any suitable variables, including availableGrouping (the AvailableGrouping used to lay out landscape, such as by Sector) and groupFilterChain (the last GroupFilter in a possible chain of filters). This example algorithm can be implemented according to the following psuedocode:

```
CREATE displayGroupList (a list of IssueGroups)
FOR each issueGroup in availableGrouping
    IF groupFilterChain does not filter issueGroup
        CREATE newIssueGroup that is empty
        ASSIGN newIssueGroup’s name to issueGroup’s name
        APPEND newIssueGroup to displayGroupList
        FOR each Issue in issueGroup
            IF groupFilterChain does not filter Issue
                APPEND Issue to newIssueGroup
            END IF
        END LOOP
    END IF
END LOOP
RETURN displayGroupList
```

Of course, it will be understood that the foregoing pseudocode examples are for illustration purposes and are not meant to limit the scope of the disclosure. Put differently, the above example algorithms are meant to help provide context and description and, instead, other algorithms may implement functions and functionality similar to or disparate from each of them while remaining within the scope of the disclosure.

Indeed, this real-time interface may be enhanced such that it can achieve or exceed 60 hz interactivity, with possible HDTV compatibility. This compatibility could allow for analysts or reporters to present highly responsive landscapes on advanced monitors, televisions, or broadcast channels. To help meet this high level of interactivity, particularly of such large data sets, various graphical optimizations may be implemented. These graphical optimizations can include geometry or vertex optimizations, color map optimizations, and such. For example, one implementation of the geometry optimization may be based on the following example algorithm:

```
geometry optimization function(...)
{
    for each GROUP
    {
        group ISSUES into ISSUE SETS with fewer than 2\hat{ }16
vertices per ISSUE SET
        for each ISSUE SET
        {
            for each ISSUE in ISSUE SET
            {
                assign ISSUE SET INDEX OFFSET to ISSUE
                create PRIMITIVE SET's by optimizing
the ISSUE's ISSUE GEOMETRY, perhaps taking into account the
size of Vertex Cache on the client
            }
            allocate ISSUE SET VERTEX ARRAY, ISSUE SET
NORMAL ARRAY, and ISSUE SET COLOR ARRAY
            pre-Multiply ISSUE SET Verticies by GROUP
MATRIX TRANSFORM
            compile ISSUE SET to OpenGL Display List
        }
    }
}
```

In the foregoing example pseudocode, the variables are generally defined as i) ISSUE—this is a securities issue, typically identified uniquely by International Securities Identification Number (ISIN), Committee on Uniform Security Identification Procedure (CUSIP) number, or Stock Exchange Daily Official List (SEDOL) number; ii) ISSUE GEOMETRY—the vertices, normals, colors, and indices representing the geometry to be displayed representing an issue in 3D space; iii) ISSUE SET—a collection of ISSUES, typically used to present geometry representing; iv) ISSUES to OpenGL in an efficient manner and may not be presented to the user-interface directly; v) ISSUE SET VERTEX ARRAY—a buffer of memory holding the vertexes representing the ISSUE geometry; vi) ISSUE SET NORMAL ARRAY—a buffer of memory holding the normals associated with each vertex in an ISSUE SET; vii) ISSUE SET COLOR ARRAY—a buffer of memory holding the colors associated with each vertex in an ISSUE SET; viii) ISSUE SET INDEX OFFSET—a offset index assigned to each ISSUE identifying the location in the VERTEX/NORMAL/COLOR Array reserved for each ISSUE's Geometry data; ix) PRIMITIVE SET—a collection of optimized Geometry (e.g. Triangle Strips, Triangles, Triangle Fans, Quads, etc.); x) GROUP—this is an arbitrary grouping of ISSUES as presented in the user interface; and xi) GROUP MATRIX TRANSFORM—a 4×4 matrix representing the transform applied to each group to place its associated geometry at a particular location in 3D space.

In another example, color map optimization may be implemented for the CPU or GPU. This color map optimization be based on an algorithm such as the following example:

```
//
// Colormap Optimization (CPU)
//
colormap optimization function(...)
{
    for each ISSUE
    {
        assign floating point metric value to ALPHA
CHANNEL of each associated vertex in the ISSUE SET COLOR
ARRAY at ISSUE SET INDEX OFFSET
    }
}
colormap change operation(...)
{
    create 1D TEXTURE MAP
    set minimum, maximum color values
    set control-point color values
    linear-interpolate (or other) color values and assign
to 1D TEXTURE MAP.
    assign Fragment program UNIFORMS for Minimum and
Maximum values
    sub-load TEXTURE MAP to OpenGL.
}
//
// Colormap Optimization (GPU)
//
colormap fragment program(...)
{
    for each FRAGMENT
    {
        get metric value from FRAGMENT ALPHA CHANNEL
        get colormap minimum and maximum values from
Fragment Program UNIFORMS
        calculate TEXTURE COORDINATE by linear
interpolation (or other) of metric value between minimum
and maximum values.
        lookup Fragment Color using TEXTURE COORDINATE
index into TEXTURE MAP.
        set Fragment color.
    }
}
```

Of course, it will be understood that the foregoing are for illustration purposes and are not meant to limit the scope of the disclosure. Put differently, the above example algorithms are meant to help provide context and description and, instead, other algorithms may implement functions and functionality similar to or disparate from each of them while remaining within the scope of the disclosure.

The financial engine may also provide the user with additional workflow features that can further assist in the analysis. For example, these features can include a “hypersort” feature and a “flag-and-tag” feature. The hypersort feature is generally a combination of progressive filters and high-level sorting to refine the information to be presented. Various implementations of the sort generally follow or integrate a tree-sort. For example, the financial engine may allow the user to pick any one of the large plurality of metrics and then arrange the groups or “plates” according to that metric (often the top left is highest value). In another example, the financial engine may intelligently modify the displayed size of a group based on the group's value for that particular metric. The filtering part of hypersort allows the user to develop a chain of filters such that the landscape presents deeper levels of refinement, with each filter removing unwanted issues. To present the user with these options, the financial engine utilizes a list of groups and entries for each such group. These lists and groups (perhaps selected via drop-down boxes) can populated, modified, enabled, or secured according to user, user roles, license or account type, engine version, network bandwidth, defaults, time of day, market availability, and so forth. Moreover, the user may be able to provide his own lists (or even filter the provided lists using selections or user-provided criteria) or the remote server may communicate new or updated lists or portions thereof.

For example, the financial engine may implement a Filtering Algorithm in GroupFilter that describes how the GroupFilter class filters the issues and groups that are displayed to the user. GroupFilters can be chained so the list of displayed Issues gets successively smaller is it passes through each filter in the chain. This example algorithm may utilize any number of variables such as displayedGroupList (list of IssueGroups this filter allows to passes) and sourceFilter (an upstream GroupFilter that filters input into this filter and can be NULL). This algorithm can be implemented according to the following psuedocode:

```
SET isFiltered to true
FOR each issueGroup in displayedGroupList
    IF issueGroup contains Issue
        SET isFiltered to False
        BREAK FOR LOOP
    END IF
END LOOP
IF isFiltered is False
    IF sourceFilter is not NULL
        SET isFiltered to value returned by
sourceFilter’s filter function.
    END IF
END IF
RETURN isFiltered
```

In some implementations, the first for-loop may use a cache, which can increase speed. Specifically, rather than iterating through the list of displayed groups, the software checks whether the Issue is in a hash table containing the visible issues for that GroupFilter. The hash table can be updated every time an IssueGroup is filtered or unfiltered within the GroupFilter. If utilized, one example cache algorithm is:

```
SET group to the IssueGroup being filtered/unfiltered.
FOR each issue in group
    IF filtering group
        REMOVE issue from displayedIssueHash
    ELSE IF unfaltering group
        ADD issue to displayedIssueHash
    END IF
END FOR
```

In this example, the code may use a displayedlssueHash variable, which is a hash table containing the unfiltered Issues for this GroupFilter. Of course, it will be understood that the foregoing are for illustration purposes and are not meant to limit the scope of the disclosure. Put differently, the above example algorithms are meant to help provide context and description and, instead, other algorithms may implement functions and functionality similar to or disparate from each of them while remaining within the scope of the disclosure.

Each displayed issue, via a building, may have news items associated with it. For example, server 120 may collect news data from live feeds, such as the Dow Jones feed, which are then parsed according to story ID and ticker symbols. Once parsed, these stories can be quickly assigned to individual issues. Instead of merely listing out stories, offering headlines, or storing for subsequent user request, the client 104 may integrate a “flag-and-tag” component that provides the user with a real-time view of events as they occur. More specifically, financial engine may maintain a counter for each issue that is incremented for each news item. This counter or other scoring system can help provide a graphical understanding of news concentration or momentum. The graphical object for that issue, such as a building, could then be “tagged” with a flag or other visual notification that a recent news item exists for that issue. The counter can also be used to determine the color of that tag (e.g., green for 1-2 news items, yellow for 3-5, and red for greater than 5). Conversely, the flag-and-tag module may decrement this counter as news items age, become obsolete, or according to other suitable criteria. Indeed, the user may customize this feature so that only news items that fall within a certain set of parameters (particular news feed, positive/negative, news item type, time, sector, etc.) are considered for this flag. Further, the user may configure an auto-popup that is triggered based on the number of news items for a particular issue, segment, etc. This auto-popup may comprise a window, another flag, or a graphical representation including a “flash” of the building and so forth. As such, this flag-and-tag feature can concurrently provide the user with a view of issue valuation changes and the number of news stories associated with those changes. This feature can be particularly useful when combined with the hypersort feature.

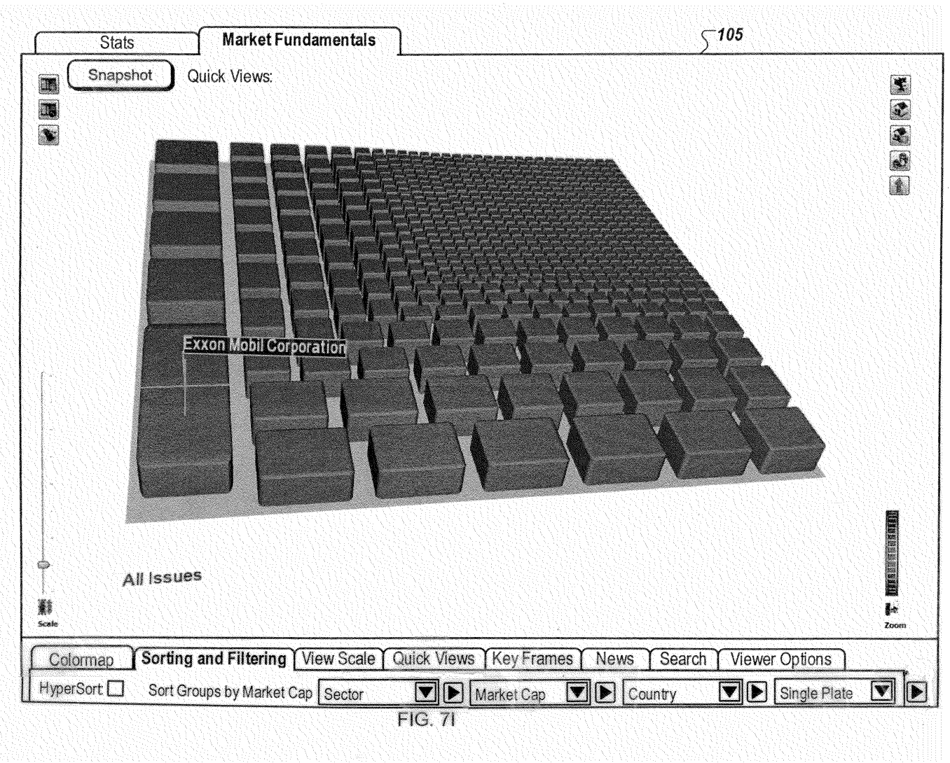

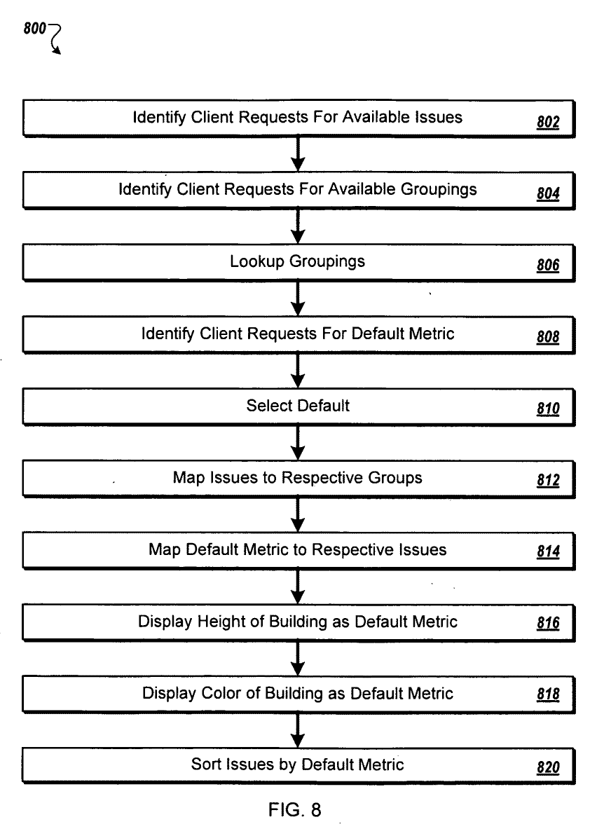

FIG. 8 illustrates an example flowchart depicting a process 800 for the selection and presentation of financial securities information within a particular implementation of the present disclosure. Generally, the process 800 involves selecting various parameters that can be provided to a financial engine 200 to determine what information to display (e.g., issues, metrics), and/or how information is to be presented (e.g., groupings, colors, dimensions). Specifically, process 800 begins at step 802, where client requests for available issues are identified. For example, the financial engine 200 can execute a getFirms( ) call to request one or more company names from a database, such as a issue/group hash-table.

Next, at step 804, client requests for available groupings are identified. For example, groupings can be made by industry sector, securities exchange, asset class, or any other appropriate category. At step 806, the financial engine 200 looks up the available groupings. For example, the financial engine 200 can execute a getlndustryGroups( ) call to request one or more groupings from a database, such as a group hash-table.

At step 808, client requests for default metric are identified. For example, the financial engine 200 can execute a getMarketCap( ) call to request the default metric from a database, such as the issue/group hash-table. At step 810, a default metric is selected.

Next, at step 812, issues are mapped to respective groups. For example, groups can be retrieved from a database, such as the issue/group hash-table. At step 814, a default metric is mapped to respective issues. For example, groups can be retrieved from a database, such as a metric/issue hash-table.

Next, at step 816, the height of a building is displayed as a default metric, and at step 818 the color of a building is displayed as a default metric. At step 820, issues are sorted by default metric. For example, the financial engine 200 can create graphical objects and place them in or more three-dimensional scenes.

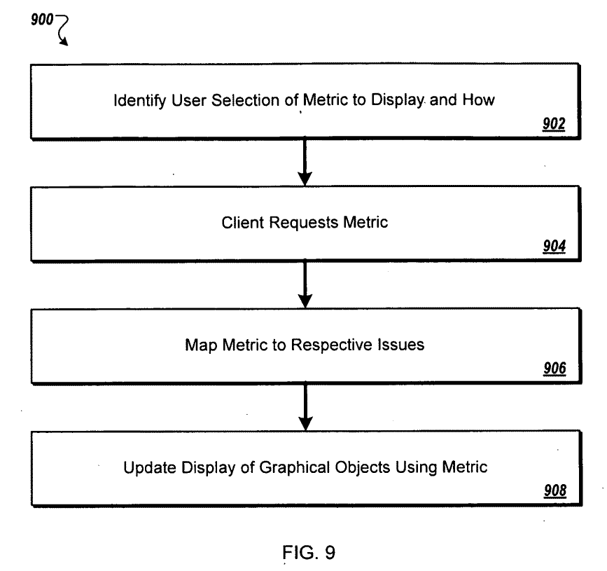

FIG. 9 illustrates an example flowchart depicting a process 900 for the updating of user metrics based on user requests. In general, the client can request a metric manually and/or programmatically, and the financial engine 200 can process those user requests and update the displayed information. Specifically, the process 900 begins at step 902, where the financial engine 200 identifies the user selection of metric to display and how. For example, the financial engine 200 can update the active metrics displayed in the GUI. In some examples, the financial engine 200 can execute a ColorBy(PERATIO) and/or a SortBy(PERATIO) call.

At step 904, the financial engine processes the request for the metric. For example, the financial engine 200 can execute a getMetricValues(PERATIO) call. In some examples, the metric values can be stored in a database, such as the metric/issue hash-table. Next, at step 906, the metric is mapped to respective issues. In some examples, the mapping can be retrieved from a database, such as the metric/issue hash-table. At step 908, a display of graphical objects using the metric is updated. For example, the financial engine 200 can update the graphics objects in one or more three-dimensional scenes.

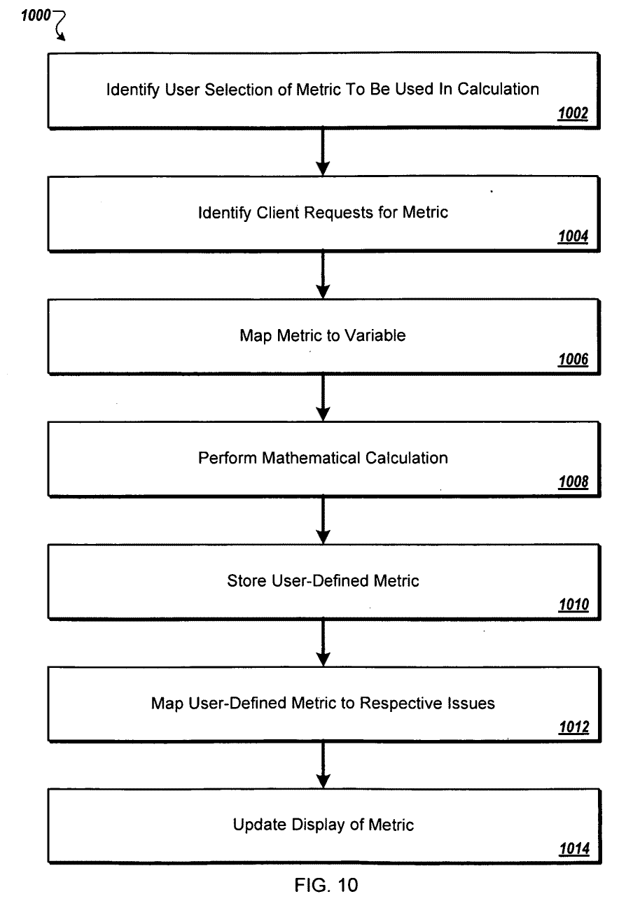

FIG. 10 illustrates an example flowchart depicting a process 1000 for calculating user defined metrics. Generally speaking, the client can specify a user-defined metric calculation, and a financial engine 200 can perform the calculation and display the results. Specifically, the process 1000 starts at step 1002, where a user selection of metrics to be used in a calculation is identified. For example, the financial engine 200 can execute calls such as userMetric(PERATIO) and/or userMetric(PEGRATIO). In some examples, a list of metrics in use can be updated in the GUI.

At step 1004, the client requests for the metric are identified. For example, the financial engine 200 can execute a getMetricValues(PERATIO) call. In some examples, the metrics can be stored in a database, such as the metric/issue hash-table. Next, at step 1006, the metric is mapped to a variable. For example, the mapping can be looked up in the metric/issue hash-table. At step 1008, mathematical calculations are performed. In some examples, the financial engine 200 can perform the calculations by executing a calcUDMO routine.

Next, at step 1010, the user-defined metric is stored. In some examples, the financial engine 200 can store the user-defined metric in a local cache or repository. At step 1012, the user-defined metric is mapped to respective issues. Next, at step 1014 the display of the metric is updated. For example, the financial engine 200 can execute calls such as UpdateColor( ) and/or UpdateSort( ) to update the graphics objects in one or more three-dimensional scenes, often implementing one or more of the optimizations described above so that the redrawn scene occurs in real time for the user, as well as in intuitive fashion.

The preceding figures and accompanying description illustrate example techniques and configurations. This disclosure contemplates using, executing, or otherwise implementing any suitable method or process for performing these and other tasks. It will be understood that these flows are for illustration purposes only and that the described or similar techniques may be performed at any appropriate time, including concurrently, individually, or in combination. In addition, many of the steps in these techniques may take place simultaneously and/or in different orders than as shown. Moreover, systems and software may use or implement methods with additional steps, fewer steps, and/or different steps, so long as the methods remain appropriate. In short, although this disclosure has been described in terms of certain embodiments and generally associated methods, alterations and permutations of these embodiments and methods will be apparent to those skilled in the art. Accordingly, the above description of example embodiments does not define or constrain the disclosure. Other changes, substitutions, and alterations are also possible without departing from the spirit and scope of this disclosure, and such changes, substitutions, and alterations may be included within the scope of the disclosure.

What is claimed is:

1. Software for presenting a three-dimensional landscape of financial information, the software comprising computer readable instructions embodied on a tangible medium and operable when executed to cause a processor to:
identify financial information to be represented in a full three-dimensional landscape by three-dimensional objects;
identify a market set of the financial information for display using the three-dimensional objects;
parse the market set of financial information into an internal data model; and
present at least a subset of the internal data model in the full three-dimensional landscape through the three-dimensional objects, the representational form of the data objects providing a relational context between the various objects.

2. The software of claim 1, the representational form such that the data objects comprise buildings and the three-dimensional landscape comprises one or more neighborhoods, each neighborhood representing a distinct category of financial information and the graphical properties of each building representing a plurality of metrics within that category.

3. The software of claim 2, the graphical properties comprising height, footprint, color, and location within the neighborhood.

4. The software of claim 1, the instructions further operable when executed to cause the processor to receive at least a portion of the market set from a remote data source.

5. The software of claim 4, the remote data source comprising a financial information repository that is communicably coupled to a plurality of third-party sources.

6. The software of claim 5, the remote data source communicably coupled to one of the third party sources via a proprietary web service.

7. The software of claim 4, the received market set formatted as encrypted GZIPed text data.

8. The software of claim 1, the instructions further operable when executed to cause the processor to perform quality checking on the identified market set.

9. The software of claim 1, the instructions further operable when executed to cause the processor to interactively respond to user input involving the landscape.

10. The software of claim 9, the dynamic response comprises redrawing the landscape at 60 hz or higher.

11. The software of claim 1, the three-dimensional landscape further presenting a one-dimensional display space and a two-dimensional display space, with each display space associated with a listener, and the instructions further operable when executed to cause the processor to notify the listener to update the particular display space upon user selection of a graphical object in the three-dimensional landscape.

12. The software of claim 1, the instructions further operable when executed to cause the processor to:
automatically refresh the financial information; and
update the three-dimensional landscape to represent a change in at least one attribute of one graphical object based on the refreshed data.

13. The software of claim 12, the instructions operable when executed to cause the processor to automatically refresh only select data items of the financial data according to a refresh value associated with each data item.

14. The software of claim 13, the refresh value for a security determined based on one or more of the following: open hours of an associated securities exchange, number of news items identified for that security, number of news items identified for a market sector of that security, and user selection.

15. The software of claim 1, the instructions operable when executed to cause the processor to enhance data flow and graphics processing such that the full three-dimensional landscape can be updated at 60 hz or higher.

16. The software of claim 15, wherein the data flow enhancement comprises populating the alpha channel of the color map with a financial metric.

17. The software of claim 15, wherein the graphics processing enhancement comprises automatically setting various parameters according to one of a determination of graphics card settings stored in a lookup table or a determination of graphics card settings determined at runtime.

18. The software of claim 1, the instructions further operable when executed to cause the processor to automatically limit the breadth of available information according to one of a user role, a license type, or user selection.

19. The software of claim 1, the instructions further operable when executed to cause the processor to reduce the identified market set according to a user's selection of a plurality of chained sorting criteria.

20. The software of claim 1, the instructions further operable when executed to cause the processor to dynamically update at least one graphic object according to news items associated with that object, the update determined according to one of news item concentration, news item severity, score, or user selection.

21. Software for presenting a three-dimensional landscape of financial information, the software comprising computer readable instructions embodied on a tangible medium and operable when executed to cause a processor to:
identify financial information to be represented in a full three-dimensional landscape by three-dimensional objects;
identify a market set of the financial information for display using the three-dimensional objects;
reduce the identified market set according to a selection of a plurality of chained sorting criteria;
parse the market set of financial information into an internal data model; and
present at least a subset of the internal data model in the full three-dimensional landscape through the three-dimensional objects, the representational form of the data objects providing a relational context between the various objects.

22. Software for presenting a three-dimensional landscape of financial information, the software comprising computer readable instructions embodied on a tangible medium and operable when executed to cause a processor to:
identify financial information to be represented in a full three-dimensional landscape by three-dimensional objects;
identify a market set of the financial information for display using the three-dimensional objects;
parse the market set of financial information into an internal data model;
present at least a subset of the internal data model in the full three-dimensional landscape through the three-dimensional objects, the representational form of the data objects providing a relational context between the various objects; and
dynamically update at least one graphic object according to news items associated with that object, the update determined according to at least one of news item concentration, news item severity, score, or user selection.
